(19) United States
(12) Patent Application Publication
(10) Pub. No.: US 2023/0380945 A1
(43) Pub. Date: Nov. 30, 2023

(54) METHOD AND DEVICE FOR APPLYING A COATING TO AN INTERDENTAL CLEANER AND INTERDENTAL CLEANER HAVING A COATING

(71) Applicant: Sunstar Suisse S.A., Etoy (CH)

(72) Inventor: Jürgen BUTZ, Utzenfeld (DE)

(21) Appl. No.: 18/249,857

(22) PCT Filed: Oct. 20, 2021
(86) PCT No.: PCT/EP2021/079096

§ 371 Date: Apr. 20, 2023

(30) Foreign Application Priority Data
Nov. 3, 2020 (DE) 10 2020 128 848.4

(51) Int. Cl. A61C 15/02; A46D 1/04; A46B 9/02

(52) U.S. Cl. CPC A61C 15/02; A46D 1/04; A46B 9/026; A46B 2200/108

(57) ABSTRACT

The invention relates to an interdental cleaner comprising a rod-like support which has a cleaning part in an axial end region, which cleaning part is provided with a coating on its external surface in a coating region. The coating region comprises merely one portion of the external surface of the cleaning part and extends preferably between two adjacent rows of cleaning elements held on the cleaning part. A transfer element is provided for applying the coating, which transfer element is provided on the outside with a coating agent and, in order to form the coating, is subsequently brought into contact with the external surface of the cleaning part.

The invention relates to an interdental cleaner having a rod-like support made of plastic, which has a cleaning part made of a soft-elastic plastic in an axial end region, wherein the cleaning part is provided with a coating on its external surface in a coating region.

Furthermore, the invention relates to a method and a device for applying a coating to an interdental cleaner.

Interdental cleaners serve to clean interdental spaces. A conventional interdental cleaner has a rod-like support made of plastic, which has a handle portion in its rear axial end region. A cleaning part made of a soft-elastic plastic is provided on the axial end region of the rod-like support opposite the handle portion. The cleaning part can be designed in the shape of a sleeve and surround the front end region of the rod-like support and, in particular, be injection-molded thereon, but alternatively it is also possible for the cleaning part to protrude beyond the front axial end region of the support.

In order to increase acceptance among consumers and to achieve an additional benefit for the consumer, it may be useful to, in the field of oral hygiene, introduce known substances and/or flavorings into the oral cavity and in particular into the interdental spaces. This can be achieved, for example, by providing the cleaning part of the interdental cleaner with a coating made of a corresponding coating agent. Various procedures are known for applying a corresponding coating. It is possible to immerse the cleaning part into a liquid supply of the coating agent to be applied and then pull it out again. This has the associated disadvantage that, in many cases, droplets are formed that, on the one hand, are aesthetically and functionally disadvantageous and, on the other hand, cause excessive coating agent to be applied to the interdental cleaner.

Alternatively, it is known to spray the coating agent onto the cleaning part. The disadvantage is thus associated with the fact that high losses of the sprayed-on medium occur during spraying and that encapsulation of the spraying chamber is necessary in order to absorb the spray mist. Furthermore, filters must be used to prevent the spray mist from entering the production environment or into the environment. Furthermore, a defined amount of coating agent cannot be applied to the cleaning part, and there is the risk that the very fine nozzles become clogged during prolonged operation, such that they first have to be cleaned before production of the interdental cleaner can continue.

In principle, the disadvantage of any known application of a coating agent is that the cleaning part is provided over the entire surface with an enclosing coating, which cures during drying and increases the flexural rigidity of the cleaning part and the cleaning elements, for example of bristles, lamellae, fingers or so-called pins. As a result, the user has no feeling of softness (soft feeling). This is only compensated for if the user inserts the interdental cleaner into their interdental space and the coating is softened again by oral saliva.

The invention is based on the object of creating an interdental cleaner of the type mentioned, which carries a defined amount of coating agent and the flexural rigidity of which is not influenced or is influenced only to a very small extent by the coating agent.

In addition, a method for applying a coating to an interdental cleaner is to be created, by which the coating agent can be applied to the cleaning part of the interdental cleaner in a simple manner and in a precise amount.

Furthermore, a device for applying a coating to an interdental cleaner is to be created, with which the method can be carried out in a simple manner.

With regard to the interdental cleaner, the above-mentioned object is achieved by an interdental cleaner having the features of claim 1. Thereby, it is provided that the coating region comprises only a partial region of the external surface of the cleaning part. Thus, the cleaning part of the interdental cleaner carries the applied coating agent only on a partial region of its external surface. The other regions of the external surface do not carry any coating agent. Since the cleaning part in the embodiment according to the invention is not completely surrounded or enclosed by a coating, but the coating is applied only in a partial region, in practice the coating does not impair the flexural rigidity of the interdental cleaner. The size of the partial region is preferably less than 50% and in particular less than 20% of the total external surface of the cleaning part.

In a preferred embodiment, it is provided that the coating region or partial region of the external surface of the cleaning part having the coating extends in the longitudinal direction of the support. This is the case, for example, if the coating is applied to the cleaning part in a strip-like configuration. A corresponding strip-like coating region can either extend in the axial direction, i.e. in the longitudinal direction of the interdental cleaner, but it can also be provided that a corresponding strip-like partial region runs helically around the cleaning part.

In a further development of the invention, it can be provided that the front tip portion of the cleaning part facing away from the handle part is not provided with a coating over a length of at least 0.5 mm and, in particular, in the range from 0.5 mm to 1.5 mm. In this manner, it is ensured that the tip portion of the cleaning part is kept soft and flexible so as not to adversely affect the user's sensation when the interdental cleaner is inserted into the interdental space. Keeping the tip portion free of the coating agent can be achieved either by the transfer body being so short that it does not come into contact with the tip portion of the cleaning part, but alternatively it is also possible to provide recesses in the transfer body, wherein the tip portion of the cleaning part, upon contact of the transfer body, is arranged in the region of the recesses and is thus not in contact with the transfer body.

With an interdental cleaner, it is usually provided that the cleaning part carries a plurality of cleaning elements projecting radially outward. The cleaning elements can, for example, be fingers formed from the same soft-elastic plastic as the cleaning part, for example a thermoplastic elastomer, and integrally bonded to the cleaning part. For example, the fingers may have a circular conical shape that tapers radially outward. Alternatively or additionally, the cleaning part can carry cleaning elements in the form of bristles projecting radially outward. Bristles are sections of a monofilament or a multifilament cut to a predetermined length from the latter. The bristles can be processed as individual bristles and/or as a bundle of bristles and are preferably arranged so that they penetrate the cleaning part and also the rod-like support, protrude axially on both sides from the cleaning part and are embedded in and held in the material of the cleaning part and in the material of the support.

In the following, it is assumed by way of example that the cleaning elements are the aforementioned integrally formed fingers, but the invention is not limited thereto.

The cleaning elements or fingers may be arranged on the external surface of the cleaning part to form a plurality of rows of cleaning elements or fingers extending in the longitudinal direction of the support. In a further development of the invention, it can be provided that the coating region is arranged between two adjacent rows of the cleaning elements or fingers. Thereby, it can be provided that only one of the spaces formed between two adjacent rows of cleaning elements or fingers is provided with the coating, while all other corresponding spaces are free of the coating. Alternatively, however, it is possible for every second interdental space or every third interdental space to be provided with a corresponding coating over the circumference of the interdental cleaner.

The coating region can extend over the entire axial length of the cleaning part. Preferably, it is provided that the coating region extends over at least 50% of the axial length of the cleaning part and, in particular, over at least 80% of the axial length of the cleaning part.

The cleaning part preferably has a sleeve-like cover formed from the soft-elastic plastic material, for example a thermoplastic elastomer, arranged on the support, which is in particular injection-molded onto the support. The spraying process may also be used to form the cleaning elements in the form of fingers and/or lamellae.

The coating agent forming the coating can be an antimicrobial substance, for example CHX chlorhexidine or CPC cetylpyridinium chloride and/or essential oils and/or remineralizing substances, for example fluorides or isomalt. and/or flavorings and/or anti-inflammatory substances containing, for example, chamomile, ginger aloe vera, and/or desensitizing substances, for example potassium nitrate, and/or probiotics, for example Lactobacillos reuteri, and/or dentin-strengthening substances, for example hesperidin, or mixtures of the above-mentioned and other substances known in oral hygiene, for example zinc fluoride.

With regard to the method, the above-mentioned object is achieved by providing a transfer body at least on the outside and at least in portions with a coating agent, whereupon the transfer body is brought into contact with the external surface of the cleaning part to form the coating. Due to the size of the contact area between the transfer body and the external surface of the cleaning part, the size of the coating region to be formed can be adjusted very precisely. The flexible adjustment of the amount of coating agent to be applied can be achieved by a user by also adjusting parameters such as the speed of the transfer body and/or the geometry of the cleaning part of the interdental cleaner and/or the geometry of the transfer body and/or the surface structure of the transfer body and, in particular, the size of a contact area between the transfer body and the cleaning part of the interdental body. It has been shown that the amount of coating agent applied to the external surface of the cleaning part by means of the transfer body can be kept within narrow predetermined limits.

The cleaning part can be provided with the coating agent over its entire length, but it is also possible to provide only a partial region of the length of the cleaning part with the coating agent, for example only the rear region facing the handle portion or only the front region facing away from the handle portion.

The application of the coating agent to the transfer body can be achieved by brushing or spraying. However, the coating agent is preferably applied by immersion, by immersing the transfer body in a coating agent bath.

The transfer body can have a cylindrical shape and, in particular, a circular cylindrical shape or a conical shape and, in particular, a circular conical shape. Depending on the viscosity of the coating agent to be applied, different transfer bodies can be used. In particular, the transfer body can have a flattened and, in particular, planar surface region. This can be achieved, for example, by a cylinder with a polygonal cross-section, in particular a triangular, square or hexagonal cross-section. By forming planar surfaces, a defined contact area between the transfer body and the cleaning part can be achieved, and it is possible to ensure that the coating agent can run off the transfer body, regardless of its viscosity.

If the cleaning part carries a plurality of radially outwardly projecting cleaning elements, for example fingers of the type mentioned, which are arranged in at least two rows extending in the longitudinal direction of the support, it can be provided in a further development of the method that the transfer body is inserted into a space formed between two adjacent rows. In this manner, the coating agent located on the outside of the transfer body is applied to the surface regions of the cleaning part forming the bottom of the space.

Preferably, the transfer body is also brought into contact with the side surfaces of the cleaning elements or fingers facing the space, such that such side surfaces are also provided with the coating agent. It can be provided that the cleaning elements or fingers are elastically deformed by the transfer body if it is inserted into the space formed between two adjacent rows. This ensures that the cleaning elements or fingers are clamped against the surface of the transfer body from the outside and absorb a sufficient amount of coating agent.

In order to improve the absorption of the coating agent on the external surface of the cleaning part, the cleaning part, in particular if it is made of a thermoplastic elastomer, can be subjected to a surface treatment at least in portions and in particular at least in the coating region before the coating is applied. The surface treatment can be roughening and/or heating and/or corona treatment and/or plasma treatment.

The specified coating method can be performed on individual interdental cleaners. However, it makes economic sense to simultaneously apply the partial coating to a plurality of interdental cleaners. For this purpose, it can be provided that several interdental cleaners are combined to form an interdental cleaner group and connected to one another, in particular via connecting bars. For example, a group can consist of eight or more interdental cleaners arranged next to one another.

A device according to the invention for applying a coating to an interdental cleaner of the aforementioned type is characterized by a transfer body that can be adjusted relative to the interdental cleaner between a receiving position, in which it can be brought into contact with a coating agent at least in portions and at least on the outside, and a dispensing position, in which the transfer body carrying the coating agent is in contact with the external surface of the cleaning part.

A coating bath can be provided to absorb the coating agent, which has a basin filled with the coating agent into which the transfer body can be immersed. The transfer body is preferably attached to a holder that is adjustable, for example vertically, and with the adjustment of which the transfer body can preferably be completely immersed in the coating bath.

The interdental cleaner can be arranged with its cleaning part above the coating bath, such that the transfer body can be lifted out of the coating bath by a purely vertical translational movement and brought into contact with the external surface of the cleaning part in its dispensing position.

The transfer body can be made of a plastic and, in particular, of a porous material, for example, an open-pore or a closed-pore plastic foam. However, the transfer body is preferably made of metal and, in particular, preferably stainless steel.

The external surface of the transfer body can be pretreated to improve uniform absorption of the coating agent over the entire surface. The pretreatment can be an external corona treatment and/or an external roughening of the transfer body. A corresponding roughening is preferably produced by mechanical processing, for example by sandblasting, grinding or by etching or eroding.

The device can be designed so that only one interdental cleaner can be coated at a time. However, at least one interdental cleaner group formed from a plurality of interdental cleaners is preferably provided with a corresponding coating. Each interdental cleaner can be assigned its own transfer body, such that the transfer bodies are also arranged in a corresponding transfer body group. In a particular further development of the device, it is provided that several interdental cleaner groups are provided with the coating simultaneously in one working step, for which purpose several corresponding transfer body groups are preferably provided, which are coupled in their movements, i.e. preferably simultaneously immersed in the coating bath and also preferably simultaneously reach their dispensing position, in which they are in contact with the external surface of the respectively assigned cleaning part.

Further details and features of the invention will become apparent from the following description of an embodiment with reference to the drawings. in which:

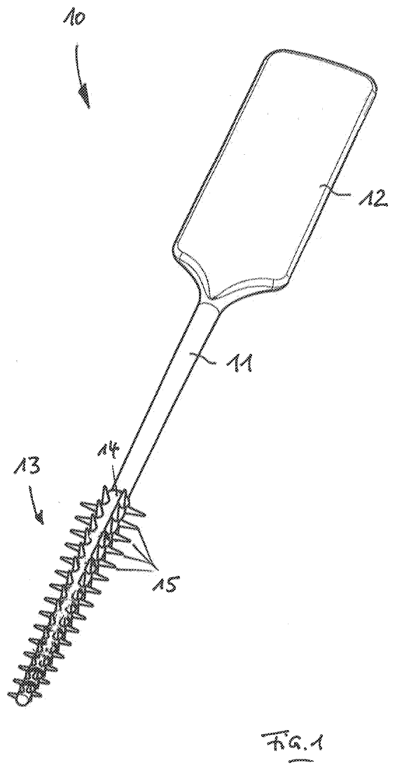

FIG. 1 shows a schematic perspective view of an interdental cleaner,

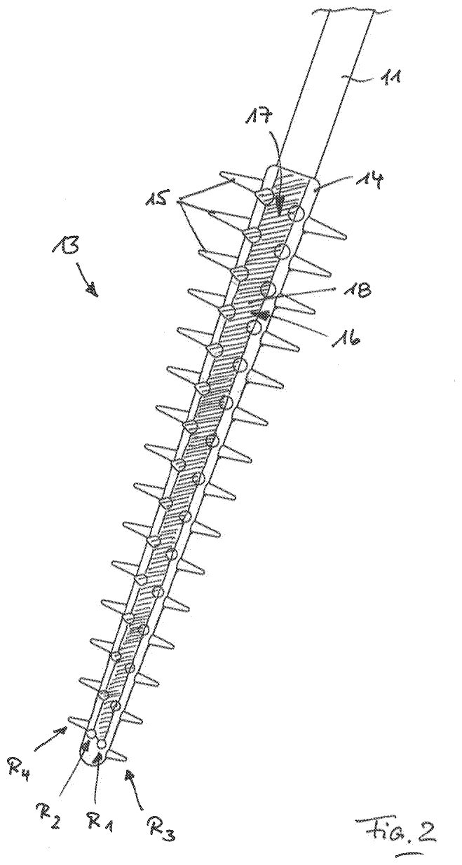

FIG. 2 shows an enlarged view of the cleaning part of the interdental cleaner according to FIG. 1,

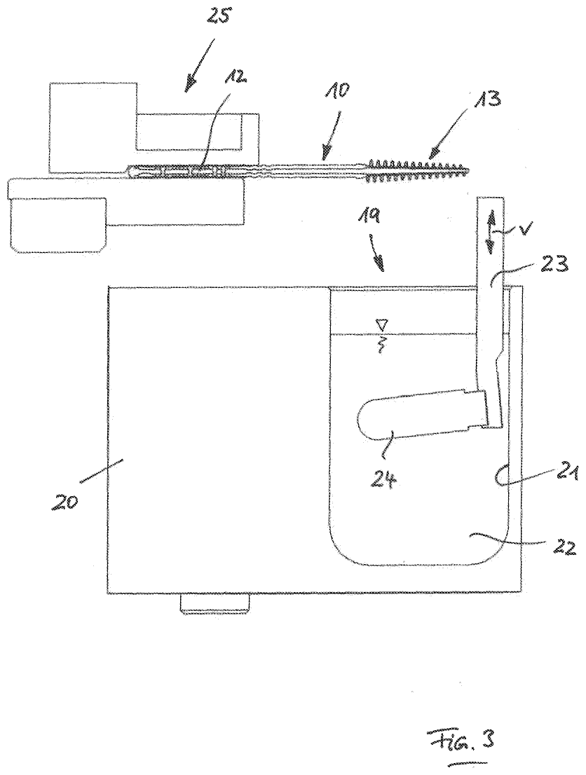

FIG. 3 shows a schematic sectional view of a device for applying a coating to an interdental cleaner, wherein the transfer body is located in its receiving position,

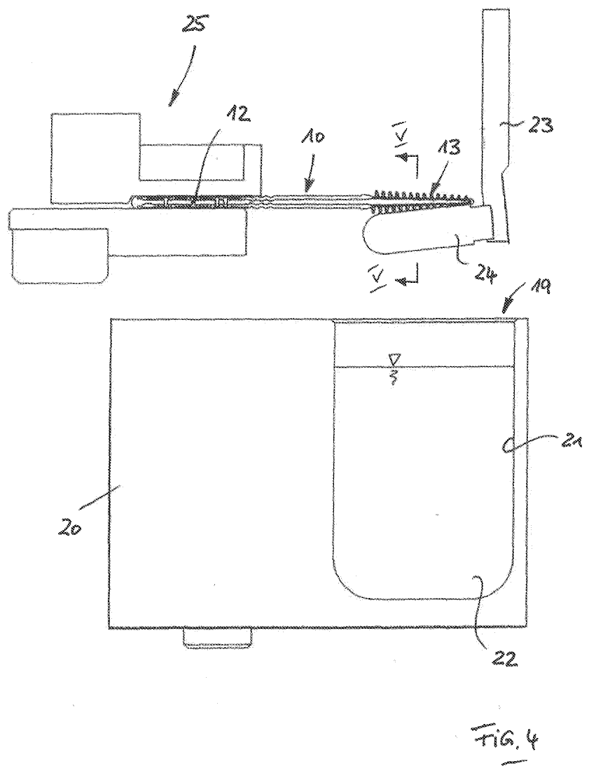

FIG. 4 shows a view corresponding to FIG. 3, wherein the transfer body is located in its dispensing position,

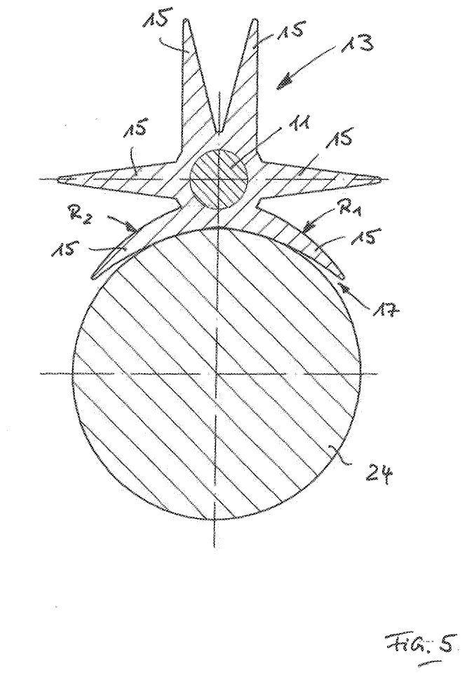

FIG. 5 shows the section V-V in FIG. 4,

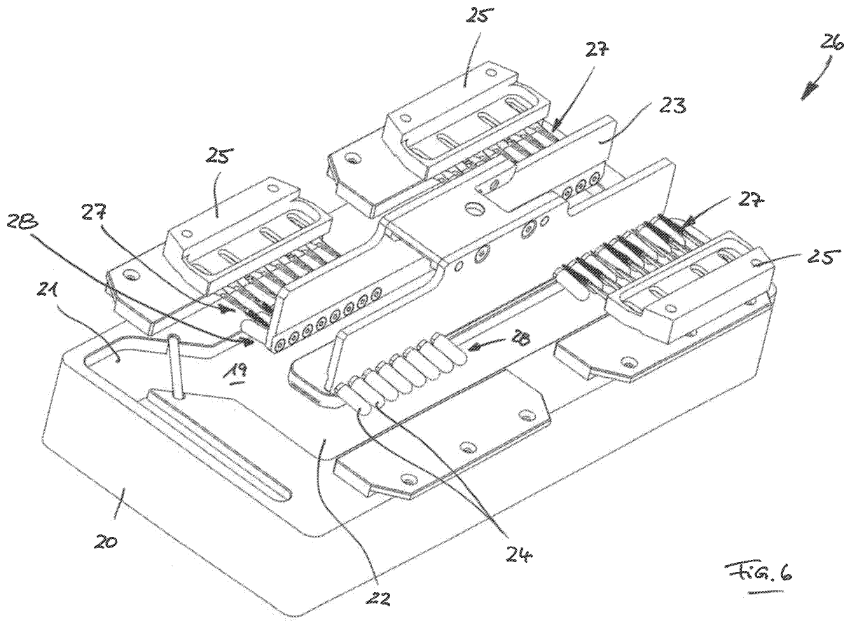

FIG. 6 shows a schematic perspective view of a device for simultaneous application of a coating to a plurality of interdental cleaners,

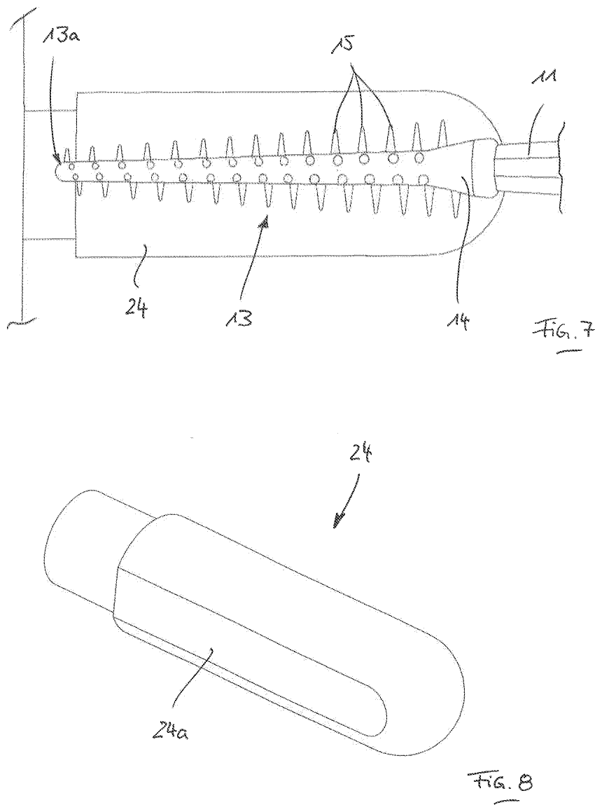

FIG. 7 shows a top view of the transfer body and the cleaning part during coating, and

FIG. 8 shows a special embodiment of the transfer body.

FIG. 1 shows a perspective view of an interdental cleaner 10, which has a rod-like support 11 made of a dimensionally stable plastic, on which a plate-like handle portion 12 is integrally formed at its axially rear end. A cleaning portion 13 is formed on the support 11 at the opposite front axial end. The cleaning portion 13 has a sleeve-like cover 14 of the support 11, which extends at the front end of the support 11 over approximately one third of the length of the interdental cleaner 10. The sleeve-like cover 14 is made of a soft-elastic material, for example a thermoplastic elastomer, and carries on its external surface radially outwardly projecting cleaning elements 15 in the form of integrally formed, conical fingers.

As shown in particular in FIG. 2, the cleaning elements 15 are arranged in the form of a plurality of rows R₁, R₂, R₃, R₄ extending in the longitudinal direction of the support 11, wherein a strip-like space 17 extending in the longitudinal direction of the interdental cleaner 10 is formed in each case between two adjacent rows. One of the spaces 17 is used to form a coating region 18. The coating region 18 comprises the bottom of the space 17, i.e., the external surface of the cleaning part arranged between the two adjacent rows R₁, R₂, and also partial surface regions of the cleaning elements 15 facing the space 17.

A coating 16, for example of a dental care agent, is applied in the coating region 18.

A device for applying the coating 16 to the interdental cleaner 10 is shown schematically in FIG. 3. The device comprises a housing 20 in which a basin 21 is formed, which basin is open at the top and in which a coating agent bath 19 having a liquid coating agent 22 is located.

A holder 23 is vertically adjustable, as indicated by the double arrow V, and carries a transfer body 24, which in the case shown is in the form of a circular cylinder attached at its rear end to the holder 23 and spherically rounded at its opposite front end. The transfer body 24 can be made of metal and, in particular, steel, and can be treated on its surface to improve absorption or wetting with the coating agent 22.

A holding device 25 is arranged above the housing 20, in which holding device an interdental cleaner 10 is clamped and held with its rear handle portion 12. The front cleaning part 13 of the interdental cleaner 10 is arranged in a freely cantilevered manner above the coating agent bath 19.

According to FIG. 3, the transfer body 24 is in its receiving position, in which it is completely immersed in the coating agent 22 of the coating agent bath 19. The holder 23 is then moved vertically upwards until the transfer body 24 comes into contact with the external surface of the cleaning part 13. Such dispensing position is shown in FIG. 4.

As can be seen from the sectional view according to FIG. 5, the transfer body 24 thereby engages the space 17 formed between two adjacent rows R₁, R₂ of the cleaning elements 15 and thereby elastically deforms the cleaning elements 15 and presses them laterally outward such that the surfaces of the cleaning elements 15 facing the space 17 and the bottom of the space 17 come into contact with the surface of the transfer body 24 over a large area, thereby transferring the coating agent 22.

FIG. 6 shows a schematic and partially simplified illustration of a device 26 for simultaneously providing a plurality of interdental cleaners 10 with the coating. According to the illustrated exemplary embodiment, four interdental cleaner groups 27 are provided, each consisting of 8 interdental cleaners 10. The interdental cleaners 10 of each interdental cleaner group 27 are connected to one another and are each clamped in a holding device 25.

Four transfer body groups 28 are provided, each having eight transfer bodies 24, wherein each transfer body 24 is assigned to an interdental cleaner 10 in said manner. The transfer body groups 28 are all arranged on the common holder 23 and thus synchronized in their movement. By lowering the holder 23, all transfer body groups 28 may be simultaneously immersed in the coating agent bath 19 and then simultaneously adjusted to the respective dispensing position, in which a respective transfer body 24 comes into contact with the cleaning part 13 of the assigned interdental cleaner 10 and transfers the coating agent.

As FIG. 7 shows, in a special embodiment of the invention, it can be provided that a tip portion 13a formed at the front end of the cleaning part 13 does not come into contact with the transfer body 24, and thus the coating agent in such tip portion 13a is not applied to the cleaning part 13. This results in the tip portion 13a remaining soft, elastic and flexible.

FIG. 8 shows a special embodiment of the transfer body 24, which has a basically cylindrical shape with a spherical rounding formed at the front end. On at least one side of the transfer body 24, a planar surface region 24a extending in the longitudinal direction of the transfer body 24 is formed, which surface region extends approximately along the entire length of at least the cylindrical part of the transfer body 24.

1. An interdental cleaner comprising a rod-like support made of plastic, which has a cleaning part made of a soft-elastic plastic in an axial end region, wherein the cleaning part is provided with a coating on an external surface thereof in a coating region, and wherein the coating region comprises only a partial region of the external surface of the cleaning part.

2. The interdental cleaner according to claim 1, wherein the coating region extends in a longitudinal direction of the rod-like support.

3. The interdental cleaner according to claim 1, wherein the cleaning part carries a plurality of radially outwardly projecting cleaning elements arranged in at least two rows extending in a longitudinal direction of the rod-like support, and the coating region is arranged between two adjacent rows of the at least two rows.

4. The interdental cleaner according to claim 1, wherein the coating region extends over at least 50% of an axial length of the cleaning part.

5. The interdental cleaner according to claim 1, wherein the cleaning part has a sleeve-like coating arranged on the rod-like support.

6. The interdental cleaner according to claim 1, wherein the coating is formed by an antimicrobial substance and/or by an essential oil and/or by a remineralizing substance and/or by a flavoring substance and/or by an anti-inflammatory substance and/or by a desensitizing substance and/or by probiotics and/or by a dentin-strengthening substance or by mixtures of the specified substances.

7. The interdental cleaner according to claim 1, wherein a front tip portion of the cleaning part is free of coating.

8. A method for applying a coating to an interdental cleaner which has a rod-like support and a cleaning part made of a soft-elastic plastic, the method comprising providing a transfer body at least on an outside thereof and at least in portions with a coating agent, bringing the transfer body into contact with an external surface of the cleaning part to form the coating.

9. The method according to claim 8, further including immersing the transfer body in a coating agent bath.

10. The method according to claim 8, wherein the cleaning part carries a plurality of radially outwardly projecting cleaning elements arranged in at least two rows extending in a longitudinal direction of the rod-like support, and the transfer body is inserted into a space formed between two adjacent rows of the at least two rows.

11. The method according to claim 10, wherein the cleaning elements are elastically deformed by the transfer body.

12. The method according to claim 8, wherein the cleaning part is corona-treated and/or plasma-treated at least in portions before the coating is applied to the external surface thereof.

13. The method according to claim 8, wherein a front tip portion of the cleaning part is left free of coating.

14. A device for applying a coating to an interdental cleaner comprising a rod-like support and a cleaning part made of a soft-elastic plastic, and a transfer body that can be adjusted relative to the interdental cleaner between a receiving position, in which the transfer body can be brought into contact with a coating agent at least in portions and at least on an outside thereof, and a dispensing position, in which the transfer body carrying the coating agent is in contact with an external surface of the cleaning part.

15. The device according to claim 14, further including a coating bath into which the transfer body can be immersed.

16. The device according to claim 14, wherein the transfer body is roughened on the outside.

17. The device according to claim 14, wherein the transfer body is made of steel.

18. The device according to claim 14, wherein a recess is formed in the transfer body, in which a tip portion of the cleaning part can be received without contact.
